(19) United States
(12) Patent Application Publication
(10) Pub. No.: US 2021/0278512 A1
(43) Pub. Date: Sep. 9, 2021

(54) Ascertainment of range limits for Lidar devices

(71) Applicant: Robert Bosch GmbH, Stuttgart (DE)

(72) Inventors: Chengxuan Fu, Ditzingen (DE); Gabriela Samagaio, Nogueira e Silva Escure, Maia (PT); Ricardo Martins Costa, Esposende (PT)

(21) Appl. No.: 17/193,203

(22) Filed: Mar. 5, 2021

(30) Foreign Application Priority Data
Mar. 5, 2020 (DE) 102020202800.1

(51) Int. Cl. G01S 7/497

(52) U.S. Cl. CPC G01S 7/497

(57) ABSTRACT

A method for ascertaining a range limit of a LIDAR device, due to environmental influences, by use of a control unit is provided. For ascertaining distances between the LIDAR device and at least one surface in a scanning area, beams are emitted into the scanning area by a transmitting unit of the LIDAR device, and beams that are reflected and/or backscattered from the scanning area are received by a receiving unit of the LIDAR device. The distances between the LIDAR device and the surface are computed based on the propagation times of the transmitted beams and of the reflected and/or backscattered beams. A range limit of a maximum possible range of the LIDAR device is ascertained based on a variance of the computed distances. Moreover, a control unit and a LIDAR device are provided.

### CROSS REFERENCE

The present application claims the benefit under 35 U.S.C. § 119 of German Patent Application No. DE 102020202800.1 filed on Mar. 5, 2020, which is expressly incorporated herein by reference in its entirety.

### FIELD

The present invention relates to a method for ascertaining a range limit of a LIDAR device due to environmental influences. Moreover, the present invention relates to a control unit and a LIDAR device.

### BACKGROUND INFORMATION

In the field of automated driving assistance functions and automated driving, LIDAR devices are typically used for carrying out a surroundings perception. With the aid of a LIDAR device, the surroundings may be scanned in order to ascertain a three-dimensional point cloud including pieces of distance information concerning objects in the scanning area. Propagation time measurements or so-called time-of-flight measurements are carried out, and distances covered by the emitted beams are computed based on the measured propagation times.

LIDAR devices may have a maximum possible range of 300 m, depending on the power of the beam sources used. The maximum possible range is a function of the reflectivity of a surface at which the emitted beams are reflected. In addition, environmental influences such as fog, snow, dust, or rain may result in a range limit of the maximum possible range of the LIDAR device.

A LIDAR device with a limited range cannot be used, or can be used only to a limited extent, for carrying out automated driving functions. No algorithms or functions are presently known that are able to determine the situation-dependent maximum possible range of a LIDAR device.

### SUMMARY

An object of the present invention includes providing a method that may check an availability of a maximum possible range of a LIDAR device.

This object may be achieved with the aid of the particular subject matter of example embodiments of the present invention. Advantageous embodiments of the present invention are disclosed herein.

According to one aspect of the present invention, a method for ascertaining a range limit, due to environmental influences, by use of a control unit is provided.

In accordance with an example embodiment of the present invention, for ascertaining distances between the LIDAR device and at least one surface in a scanning area, beams are emitted into the scanning area by a transmitting unit of the LIDAR device. Beams that are reflected and/or backscattered from the scanning area are received by a receiving unit of the LIDAR device. The distances between the LIDAR device and the surface are computed based on the propagation times of the transmitted beams and of the reflected and/or backscattered beams.

The distances may be ascertained in the form of a two-dimensional or three-dimensional point cloud. For this purpose, beams may be generated by one or multiple beam sources of the LIDAR device and emitted along the scanning area. For this purpose, the LIDAR device may be designed as a scanner or a flash LIDAR. Beams that are backscattered and/or reflected from the scanning area are subsequently received and detected by at least one detector of the LIDAR device. The beams may be reflected or backscattered at arbitrary surfaces or objects in the scanning area.

Propagation times of the beams that are emitted into the scanning area and received from the scanning area are measured. The distances between the LIDAR device and the particular surface are computed based on the measured propagation times.

A plurality of measurements per second may preferably be carried out, a plurality of distances per second being ascertained. The distances may be ascertained from one section or from different sections of the scanning area in order to implement a surroundings perception.

A range limit of a maximum possible range of the LIDAR device is ascertained based on a variance of the computed distances.

A theoretical maximum possible range or the maximum detection range of the LIDAR device may be determined via a method in accordance with an example embodiment of the present invention. The maximum detection range of the LIDAR device may be limited by environmental influences, such as the weather or soiling of the LIDAR device. Such range limits of the maximum detection range of the LIDAR device may be ascertained based on the computed variance of the distances.

The method may take into account fog, sand particles, dust particles, rain, snow, and/or soiling of the LIDAR device due to water, mud, or snow as environmental influences which impair the theoretical maximum possible range of the LIDAR device.

In particular, the method is based on the fact that for certain intensity ranges, the maximum detection range of LIDAR devices is a function of the variance of the measured distances. The variance when there is impairment of the theoretical maximum range of the LIDAR device is higher compared to an unimpaired LIDAR device.

With increasing variance of the ascertained distances, the range limit increases and the physically maximum possible range of the LIDAR device decreases, since the generated beams are already scattered at aerosols or particles shortly after exiting the LIDAR device.

In contrast, a reduced variance of the distances indicates a small range limit, so that the generated beams of the LIDAR device are scattered or reflected at a greater distance from the LIDAR device. The LIDAR device has a greater physically possible range and a small range limit.

In the actual surroundings, surfaces with a high reflectivity, such as mirrors, rarely occur. The range limit due to environmental influences for surfaces with a low reflectivity has a much greater effect than for surfaces with a high reflectivity. Thus, when surfaces with a high reflectivity are present, the actual range of the LIDAR device that is impaired by environmental influences may be greater than assumed by the method, based on the range limit. Such a classification of the range limit by the method may improve the reliability of an operation of an automated driving function, since a driving function is not erroneously operated using measured data of a degraded or limited LIDAR device.

According to a further aspect of the present invention, a control unit is provided, the control unit being configured to carry out the method. The control unit may, for example, be integrated into the LIDAR device or be connectable to the LIDAR device. In addition, the control unit may be designed as a cloud technology that is connectable to the LIDAR device via a wireless communication link.

According to a further aspect of the present invention, a LIDAR device for scanning a scanning area is provided. The LIDAR device includes a transmitting unit with at least one beam source for generating and emitting beams into the scanning area, and a receiving unit for receiving and detecting beams that are reflected and/or backscattered from the scanning area. The LIDAR device includes a control unit according to the present invention or is connectable to such a control unit. The control unit may be connectable to the LIDAR device via a communication link in a data-transmitting manner in order to receive and evaluate measured data of the LIDAR device.

The control unit is also configured to execute control commands that may influence or control an automated driving function. In addition, the control unit may evaluate measured data and compute variances of ascertained distances or ranges.

The method may preferably increase the operational reliability of automated driving functions. Such automated driving functions may allow an assisted, semi-automated, highly automated, and/or fully automated or driverlessly operable control of a vehicle according to the BASt (German Federal Highway Research Institute) standard.

A vehicle that carries out the automated driving function may be designed as a land vehicle, watercraft, or aircraft. For example, the vehicle may be designed as a passenger automobile, robotaxi, drone, airplane, boat, truck, and the like.

The automated driving function may allow a control of transverse guiding functions and/or longitudinal guiding functions. The control unit may determine and classify a range limit of the LIDAR device, and thus the performance of the LIDAR device, by evaluating the measured data of the LIDAR device. The control unit may thus check whether the automated driving function is maintained to a full extent or a limited extent, for example with a reduced speed. Depending on the ascertained range limit, driving functions may also be limited with regard to their extent and their dynamics in order to take the limitation of the LIDAR device into account. For a significant range limit, a deactivation of the driving function may also be advantageous. A vehicle may be transferred into a safe state, or may be handed over to a driver to allow a manual control.

Alternatively, the control unit may generate control commands for aborting the automated driving function and for handing over the control to a driver. According to one alternative embodiment, the control unit may also output control commands to transfer the vehicle, which carries out the automated driving function, into a safe state.

In one specific embodiment of the present invention, the range limit of the LIDAR device is computed inversely proportional to the maximum possible range of the LIDAR device. The range limit is a measure for the degradation of the theoretically possible detection range of the LIDAR device. The range limit may have an absolute or relative design. For example, the relative range limit may be a percentage reduction of the maximum possible range of the LIDAR device. An absolute range limit may be the number of meters by which the maximum possible range of the LIDAR device is reduced by environmental influences.

The range limit results from the scattering and reflection of the beams, emitted into the scanning area, at particles and aerosols, for example dust particles, raindrops, snow, fog, and the like. The greater the range limit, the smaller is the actually usable range, or the smaller is the usable detection range, of the LIDAR device.

The detection range or the range of the LIDAR device has maximum usability when the range limit is minimal or is not present.

According to a further exemplary embodiment of the present invention, an increasing range limit of the LIDAR device with an increasing variance is computed, a smaller maximum possible range of the LIDAR device being deduced from an increasing range limit of the LIDAR device. Based on an increasing variance of the computed distances, a smaller available range of the LIDAR device may thus be assumed. The variance results from the presence of particles and aerosols that are present in the beam path of the emitted beams at a small distance from the LIDAR device.

According to a further specific embodiment of the present invention, a smaller range limit of the LIDAR device with a decreasing variance is computed, a larger maximum possible range of the LIDAR device being ascertained from a smaller range limit of the LIDAR device. If the variance of the computed distances decreases, it may be assumed that the environmental influences impair the function of the LIDAR device less severely. As a result, the usable range or detection range of the LIDAR device increases.

According to a further exemplary embodiment of the present invention, the variance of the computed distances is computed from temporally smoothed distances. The distances may be temporally smoothed using rolling averages, for example. By use of this measure, measurement uncertainties and short-term deviations may be compensated for, as the result of which the ascertainment of the range limit is computed in a more robust manner.

According to a further specific embodiment of the present invention, the measured propagation times of the beams and/or the distances between the LIDAR device and the surface that are computed from the propagation times, based on measurements within an intensity range, are used for computing the variance. Only those measured values situated within the intensity range are used for ascertaining the range limit. Each measured value of the propagation time measurements has an intensity that is measured by the detector when the beams are received. By filtering or masking of the measured values on a defined intensity range, for example total reflections of reflective surfaces in the scanning area may be excluded from the determination of the range limit. The intensity range may, for example, be between 0% and 30% of the possible intensity that is detectable by the detector.

According to a further exemplary embodiment of the present invention, the range limit is classified based on value ranges of the ascertained variance. In this way, value ranges may be defined in order to carry out an unambiguous classification of the range limit. A functional limitation may be assigned to the LIDAR device as a function of the ascertained variance of the distances. For example, a slight or strong functional limitation may be assigned to the LIDAR device as a function of the ascertained value range.

Based on such a classification of the range limit, the control unit may generate control commands for adapting automated driving functions. For example, a maximum speed for an operation of automated driving functions may be limited, or automated driving functions for a strong range limit may be deactivated.

According to a further specific embodiment of the present invention, the range limit in a range of the variance of the distances between 140 m² and 180 m² is classified as “strong,” in a range of the variance of the distances between 120 m² and 140 m² is classified as “medium,” in a range of the variance of the distances between 40 m² and 120 m² is classified as “low,” and in a range of the variance of the distances between 0 m² and 40 m² is classified as “not present.” The control unit thus includes unambiguous classifications of the range limit. By use of the value ranges or classifications of the variance, measures may be taken in a targeted manner to ensure reliability during operation of the automated driving function. For example, for a strongly limited range of the LIDAR device, the functionality of the automated driving function is no longer ensured and is therefore deactivated. In contrast, when a range limit is not present, the maximum possible range of the LIDAR device may be utilized, as the result of which there are no limits on the automated driving function.

In a further specific embodiment of the present invention, control commands for adapting a driving function are generated based on the ascertained range limit. One or multiple driving functions may be adapted by the generated control commands. By use of this measure, the driving function may be adapted to the measured data of a LIDAR device that is impaired by environmental influences.

Preferred exemplary embodiments of the present invention are explained in greater detail below with reference to greatly simplified schematic illustrations.

### BRIEF DESCRIPTION OF THE DRAWINGS

FIG. 1 shows a schematic illustration of a LIDAR device according to one specific embodiment of the present invention.

FIG. 2 shows a time-distance diagram for illustrating a variance in measured values of the LIDAR device, in accordance to an example embodiment of the present invention.

FIG. 3 shows a time-variance diagram with value ranges of the variance for classifying a range limit, in accordance to an example embodiment of the present invention.

### DETAILED DESCRIPTION OF EXAMPLE EMBODIMENTS

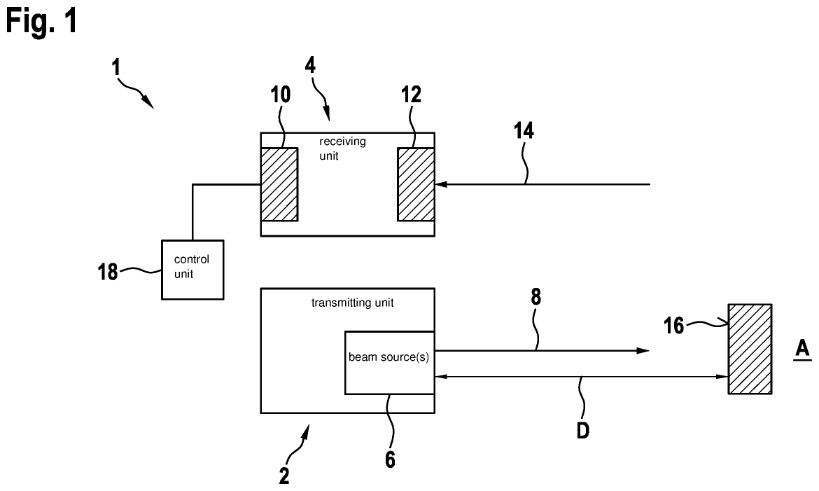

FIG. 1 shows a schematic illustration of a LIDAR device 1. LIDAR device 1 includes a transmitting unit 2 and a receiving unit 4. Transmitting unit 2 of LIDAR device 1 includes one or multiple beam sources 6 that are used to generate beams 8. Generated beams 8 may be subsequently emitted, directly or deflected via optional optical elements, into a scanning area A.

Beam source 6 is designed as a laser, for example, which may generate pulsed beams 8 in the infrared or ultraviolet wavelength range. LIDAR device 1 may be designed as a flash LIDAR or as a scanner in order to scan scanning area A, at least in areas, using generated beams 8.

Receiving unit 4 may include one or multiple detectors 10, receiving optics 12, and corresponding electronics, not illustrated, for reading out the at least one detector 10. Receiving unit 4 is used to detect backscattered or reflected beams 14. Backscattered or reflected beams 14 may be backscattered or reflected at objects or at surfaces 16 in scanning area A.

A propagation time of beams 8, 14 may be measured and a distance D between LIDAR device 1 and surface 16 may be ascertained via the transmission and reception of beams 8, 14. Backscattered or reflected beams 14 detected by detector 10 may be received and evaluated in analog or digital form as measured data by a control unit 18.

In particular, control unit 18 may generate a time-distance diagram based on the received measured data. Based on distances D computed from propagation times, control unit 18 may subsequently ascertain a variance of computed distances D, which is used as a measure for a range limit.

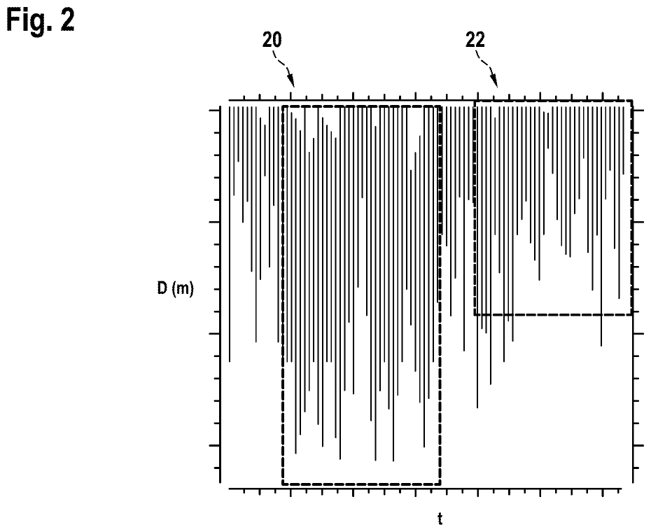

FIG. 2 shows a time-distance diagram for illustrating a variance in measured values, in particular the variance in computed distances D, of LIDAR device 1. The time-distance diagram is used to illustrate the functional principle of a method that may be carried out by LIDAR device 1 and/or by control unit 18.

Particular computed or measured distances D at particular points in time t are plotted in the time-distance diagram. The measured values may be divided essentially into two sections or value ranges 20, 22.

The variance of distances D in a first value range 20 is higher than the variance of distances D in a second value range 22. The higher variance of distances D in first value range 20 is caused, for example, by interfering influences of fog. Aerosols in the vicinity of LIDAR device 1 as well as aerosols farther away are registered. This results in greater unevenness of measured distances D. Similarly, a range limit of LIDAR device 1 that is greater compared to second value range 22 is visible in first value range 20.

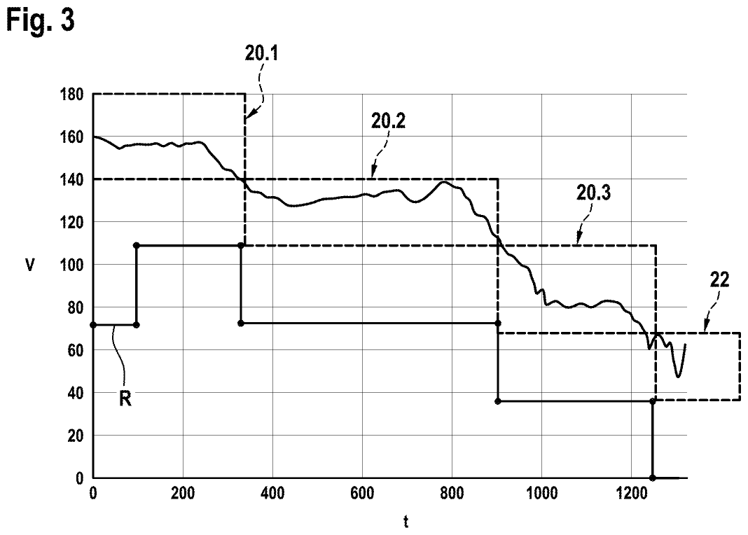

FIG. 3 illustrates a time-variance diagram with value ranges 20, 22 of variance V of distances D for classifying a range limit. Value ranges 20, 22 of variance V of distances D shown as an example in FIG. 2 may be defined according to the application. For example, a first value range 20 that results in a range limit R of LIDAR device 1 may be divided into multiple value ranges 20.1, 20.2, 20.3, 20.4 in order to ascertain a graduated limit of the functionality of LIDAR device 1. Second value range 22 may indicate a range limit of LIDAR device 1 that is not present. For a variance of distances D in second value range 22, control unit 18 ascertains a maximum range of LIDAR device 1 that is unimpaired by environmental influences.

The time-variance diagram shows an example of an ascertained variance V that has been computed based on ascertained distances D. Variance V is divided into different value ranges 20.1, 20.2, 20.3, 20.4, 22. A range limit R is correspondingly assigned to LIDAR device 1 corresponding to these value ranges 20.1, 20.2, 20.3, 20.4, 22.

Based on range limit R of LIDAR device 1, control unit 18 may generate control commands in order to adapt automated driving functions and to deactivate and/or to output warning messages.

Range limit R, having variance V in value range 20.1 with highest variance V, may be used as an indicator for deactivating

LIDAR device 1 and/or the automated driving functions. The gradations of variance V in further value ranges 20.2, 20.3, 20.4 may be used to limit the automated driving function, for example a maximum speed. No range limit R is present in variance V in second value range 22, as the result of which intervention by control unit 18 is not necessary.

1-11. (canceled)

12. A method for ascertaining a range limit of a LIDAR device, due to environmental influences, by a control unit, for ascertaining distances between the LIDAR device and at least one surface in a scanning area, the method comprising the following steps:
emitting beams into the scanning area by a transmitting unit of the LIDAR device;
receiving beams that are reflected and/or backscattered from the scanning area by a receiving unit of the LIDAR device
computing the distances between the LIDAR device and the surface based on propagation times of the transmitted beams and of the reflected and/or backscattered beams; and
ascertaining a range limit of a maximum possible range of the LIDAR device based on a variance of the computed distances.

13. The method as recited in claim 12, wherein the range limit of the LIDAR device is ascertained inversely proportional to the maximum possible range of the LIDAR device.

14. The method as recited in claim 12, wherein an increasing range limit of the LIDAR device is computed at an increasing variance, a smaller maximum possible range of the LIDAR device being deduced from the increasing range limit of the LIDAR device.

15. The method as recited in claim 12, wherein a smaller range limit of the LIDAR device is computed at a decreasing variance, a larger maximum possible range of the LIDAR device being ascertained from the smaller range limit of the LIDAR device.

16. The method as recited in claim 12, wherein the variance of the computed distances is computed from temporally smoothed distances.

17. The method as recited in claim 12, wherein the propagation times of the beams and/or the distances between the LIDAR device and the surface that are computed from the propagation times are used from measurements within an intensity range for computing the variance.

18. The method as recited in claim 17, wherein the range limit is classified based on value ranges of the computed variance.

19. The method as recited in claim 18, wherein the range limit in a value range of the variance of the distances between 140 m² and 180 m² is classified as “strong,” in a value range of the variance of the distances between 120 m² and 140 m² is classified as “medium,” in a value range of the variance of the distances between 40 m² and 120 m² is classified as “low,” and in a value range of the variance of the distances between 0 m² and 40 m² is classified as “not present.”

20. The method as recited in claim 12, wherein control commands for adapting a driving function are generated based on the ascertained range limit.

21. A control unit configured to ascertain a range limit of a LIDAR device, due to environmental influences, for ascertaining distances between the LIDAR device and at least one surface in a scanning area, the control unit configured to:
emit beams into the scanning area by a transmitting unit of the LIDAR device;
receive beams that are reflected and/or backscattered from the scanning area by a receiving unit of the LIDAR device;
compute the distances between the LIDAR device and the surface based on propagation times of the transmitted beams and of the reflected and/or backscattered beams; and
ascertain a range limit of a maximum possible range of the LIDAR device based on a variance of the computed distances.

22. A LIDAR device for scanning a scanning area, comprising:
a transmitting unit with at least one beam source configured to generate and emit beams into the scanning area;
a receiving unit configured to receive and detect beams that are reflected and/or backscattered from the scanning area; and
a control unit configured to ascertain a range limit of the LIDAR device, due to environmental influences, for ascertaining distances between the LIDAR device and at least one surface in a scanning area, the control unit configured to:
emit beams into the scanning area using the transmitting unit,
receive beams that are reflected and/or backscattered from the scanning area using the receiving unit,
compute the distances between the LIDAR device and the surface based on propagation times of the transmitted beams and of the reflected and/or backscattered beams, and
ascertain a range limit of a maximum possible range of the LIDAR device based on a variance of the computed distances.
